(19) United States
(12) Patent Application Publication
(10) Pub. No.: US 2024/0144307 A1
(43) Pub. Date: May 2, 2024

(54) SEGMENT SIZE ESTIMATION

(71) Applicant: ADOBE INC., SAN JOSE, CA (US)

(72) Inventors: Tung Mai, San Jose, CA (US); Ritwik Sinha, Cupertino, CA (US); Trevor Hyrum Paulsen, Lehi, UT (US); Xiang Chen, San Jose, CA (US); William Brandon George, Pleasant Grove, UT (US); Nate Purser, Corcoran, MN (US); Zhao Song, Seattle, WA (US)

(21) Appl. No.: 18/047,421

(22) Filed: Oct. 18, 2022

(51) Int. Cl. G06Q 30/02

(52) U.S. Cl. CPC G06Q 30/0204

(57) ABSTRACT

One aspect of systems and methods for segment size estimation includes identifying a segment of users for a first time period based on time series data, wherein the time series data includes a series of interactions between users and a content channel and wherein the segment includes a portion of the users interacting with the content channel during the first time period; computing a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment; and providing customized content to a user in the segment based on the segment return value.

### BACKGROUND

The following relates generally to user segmentation, and more specifically to segment size estimation. Data relating to users and user interactions may be aggregated so that similarities in user attributes, characteristics, user devices, and interactions can be identified. Users can be grouped into segments of users according to the identified similarities.

In some cases, the data relating to user interactions includes time information, and users can be further grouped into segments based on when the user interactions occur. When users are segmented according to time information, the time information can be used to extrapolate a size of a segment of users who will correspond to similar user attributes, characteristics, user devices, and interactions at a future time. However, conventional user prediction systems do not accurately predict a size of a future segment of users. There is therefore a need in the art for segment size estimation systems and methods that accurately predict a number of users who will belong to a future segment.

### SUMMARY

An embodiment of the present disclosure provides a system for segment size estimation that receives time series data for a user interaction with a content channel and assigns the user to a segment of similar users who have similar interactions with the content channel during a first time period. The system identifies a first subset of the segment that includes users who interact with the content channel greater than a threshold number of times during a range of the time series data and a second subset of the segment that is a complement of the first subset with respect to the segment.

Based on the first subset and the second subset, the system predicts a number of users of the segment who will interact with the content channel in a future time period. By basing the prediction on the first subset and the second subset, the system is able to more accurately predict a size of a segment of users who will interact with the content channel during the future time period than if the system had used the segment alone for the prediction. By accurately predicting a size of a future segment of users, the system is able to customize content for a user of the future segment and provide the customized content to the user in an efficient manner.

A method, apparatus, non-transitory computer readable medium, and system for segment size estimation are described. One or more aspects of the method, apparatus, non-transitory computer readable medium, and system include identifying a segment of a plurality of users for a first time period based on time series data, wherein the time series data includes a series of interactions between the plurality of users and a content channel and wherein the segment includes a portion of the plurality of users interacting with the content channel during the first time period; computing a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment; and providing customized content to a user in the segment based on the segment return value.

A method, apparatus, non-transitory computer readable medium, and system for segment size estimation are described. One or more aspects of the method, apparatus, non-transitory computer readable medium, and system include monitoring a content channel to collect time series data for a plurality of users; computing a first return value for a first subset of a segment of the plurality of users and a second return value for a second subset of the segment of the plurality of users based on the time series data, wherein the segment includes a portion of the plurality of users interacting with the content channel during a first time period, wherein the first subset includes users that interact with the content channel greater than a threshold number of times during a range of the time series data, and wherein the second subset comprises a complement of the first subset with respect to the segment; predicting a segment return value for a second time period subsequent to the first time period based on the first subset and the second subset of the segment; and providing customized content to a user in the segment based on the segment return value.

An apparatus and system for segment size estimation are described. One or more aspects of the apparatus and system include a processor; a memory including instructions executable by the processor; a segmentation component configured to identify a segment of a plurality of users for a first time period based on time series data, wherein the time series data includes a series of interactions between the plurality of users and a content channel and wherein the segment includes a portion of the plurality of users interacting with the content channel during the first time period; a prediction component configured to compute a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment; and a content component configured to provide customized content to a user in the segment based on the segment return value.

### BRIEF DESCRIPTION OF THE DRAWINGS

FIG. 1 shows an example of a segment size estimation system according to aspects of the present disclosure.

FIG. 2 shows an example of a segment size estimation apparatus according to aspects of the present disclosure.

FIG. 3 shows an example of data flow in a segment size estimation apparatus according to aspects of the present disclosure.

FIG. 4 shows an example of customizing content based on a predicted future user interaction according to aspects of the present disclosure.

FIG. 5 shows an example of providing customized content based on a segment return value according to aspects of the present disclosure.

FIG. 6 shows an example of providing customized content based on return values according to aspects of the present disclosure.

### DETAILED DESCRIPTION

Embodiments of the present disclosure relate generally to user segmentation, and more specifically to segment size estimation. Data relating to users and user interactions may be aggregated so that similarities in user attributes, characteristics, user devices, and interactions can be identified. Users can be grouped into segments of users according to the identified similarities.

In some cases, the data relating to user interactions includes time information, and users can be further grouped into segments based on when the user interactions occur. When users are segmented according to time information, the time information can be used to extrapolate a size of a segment of users who will correspond to similar user attributes, characteristics, user devices, and interactions at a future time. However, conventional user prediction systems do not accurately predict a size of a future segment of users. For example, some conventional user prediction systems make a prediction of future user behavior based on value assignments of user attributes. However, these conventional predictive systems do not take user segments into account, and are unable to gather time series data to use as a basis for a prediction. The resulting inaccuracy of the prediction diminishes a likelihood that an action taken on the basis of the prediction (for example, providing targeted content) will be efficient and effective.

In contrast, an embodiment of the present disclosure provides a segment size estimation system that uses historical time series data relating to user interactions with a content channel to identify a segment of users and to identify subdivisions of the segment based on varying levels of historical engagement with the content channel. The segment size estimation system predicts a number of users among each of the subdivisions who will return to the content channel in the future, and estimates a total number of users among the segment who will return to the content channel based on the separate predictions for the subdivisions.

By using the historical time series data to identify the segment and the subdivisions, making separate predictions for the subdivisions, and making a final segment size estimate based on the separate predictions, the segment size estimation system effectively employs user segmentation and time series data to provide a more accurate estimation of a number of users who will behave in a certain manner in the future than conventional systems can provide. The accurate estimation provided by the segment size estimation system allows the segment size estimation system to efficiently provide customized content to a user who is predicted to belong to a future segment of users.

According to some aspects, a segment size estimation system is provided. In some cases, the system includes a segmentation component, a prediction component, and a content component.

According to some aspects, the segmentation component is configured to identify a segment of a plurality of users for a first time period based on time series data. In some cases, the time series data includes a series of interactions between the plurality of users and a content channel. In some cases, the segment includes a portion of the plurality of users interacting with the content channel during the first time period.

According to some aspects, the prediction component is configured to compute a segment return value for a second time period based on the time series data by computing a first subset and a second subset of the segment. In some cases, the first subset includes users that interact with the content channel greater than a threshold number of times during a range of the time series data. In some cases, the second subset comprises a complement of the first subset with respect to the segment.

According to some aspects, the content component is configured to provide customized content to a user in the segment based on the segment return value.

By estimating a segment return value that includes a number of users who are in the segment and who are predicted to interact with the content channel during a second time period subsequent to the first time period, the prediction component therefore provides information that is useful in efficiently allocating resources to users in the segment and/or the content channel, or in determining that the segment should be exported to a data collection system. By basing the segment return value on the first subset and the second subset, the system provides a more accurate prediction of a size of a future segment of users than conventional techniques can provide.

As used herein, the “time series data” includes a series of interactions between a plurality of users and a content channel. For example, the time series data can include any data that is descriptive of a user, a content channel, and an interaction at the time of the interaction. Examples of data that are descriptive of a user includes a user name, a type of user device, a web browser of the user, a mailing address of the user, a billing address of the user, a location of the user device, an operating system of the user device, etc. Examples of data that are descriptive of a content channel include the name of the content channel, a name of a website associated with the content channel, a location of the content channel, etc. Examples of data that are descriptive of an interaction include a type of interaction (such as a visit to a URL, leaving a URL, a referrer URL, a click on a hyperlink, adding or removing a product to or from a virtual shopping cart, a check-in to a physical location using a user device, the presence of a user device within a geofenced area, etc.), a date of the interaction, a time of the interaction, etc.

As used herein, a “content channel” refers to a digital content channel through which digital “content” (such as media including text, audio, images, video, or a combination thereof) is provided, or a physical channel (such as a mailing service, a physical location such as a store, a hotel, an amusement park, etc., and the like) through which goods, services, physically tangible media, and the like (e.g., “content”) are provided. Examples of a digital content channel include a website, a software application, an Internet-based application, an email service, a messaging service (such as SMS, instant messaging, etc.), a television service, a telephone service, etc. As used herein, “customized content” refers to content that is customized according to data associated with a segment.

As used herein, a “time period” refers to an interval of time that includes a start time, an end time, and times between the start time and the end time. A time period can be measured in terms of seconds, minutes, days, months, years, etc. In some cases, the times between the start time and the end time are continuous. In some cases, the times between the start time and the end time are discontinuous.

As used herein, in some cases, a “segment return value” refers to a numerical representation of a number of users who are included in the segment and who are also predicted to interact with the content channel in a second time period subsequent to the first time period.

An example of an efficient allocation of resources is a determination of content to be provided to a user of the segment when it is known, via the segment return value, that the user is likely to have a repeat interaction with the content channel during a future time period. Another example of an efficient allocation of resources is determining an amount of bandwidth, servers, cloud-based services, and the like that should be provided for the content channel based on the segment return value.

An example application of the present disclosure is in a content distribution context. In an example use case, a user from New York visits a home page of a website on a first day with a particular browser installed on a particular type of smartphone. The system receives this information from the website via a cookie that the website reports to the system. The system uses the information in the cookie to assign the user to a segment of users who interact with the website on the first day with the particular browser and the particular type of smartphone. Based on data that the system has received for users who have interacted with the website on previous days with the particular browser and smartphone, the system estimates a number of users in the segment who will interact with the website on a following day.

For example, the system identifies a first subset of the segment including users in the segment who have interacted with the website more than once during the first day based on data received from the website, and identifies a second subset of users in the segment as including the remaining users in the segment. The system then predicts a number of users in the first subset and in the second subset who will visit the website on the following day (irrespective of user location, browser, and user device), respectively, and computes a segment return value based on the prediction.

In response to computing the segment return value that indicates a number of return visitors to the website from among the users in the segment, the system determines that the user is likely to return to the website on the following day and that it is an efficient use of resources to provide to the user a video that is customized for users from New York who visit the website using the browser and the particular type of smartphone. The system then displays the video to the user via the website in response to the determination.

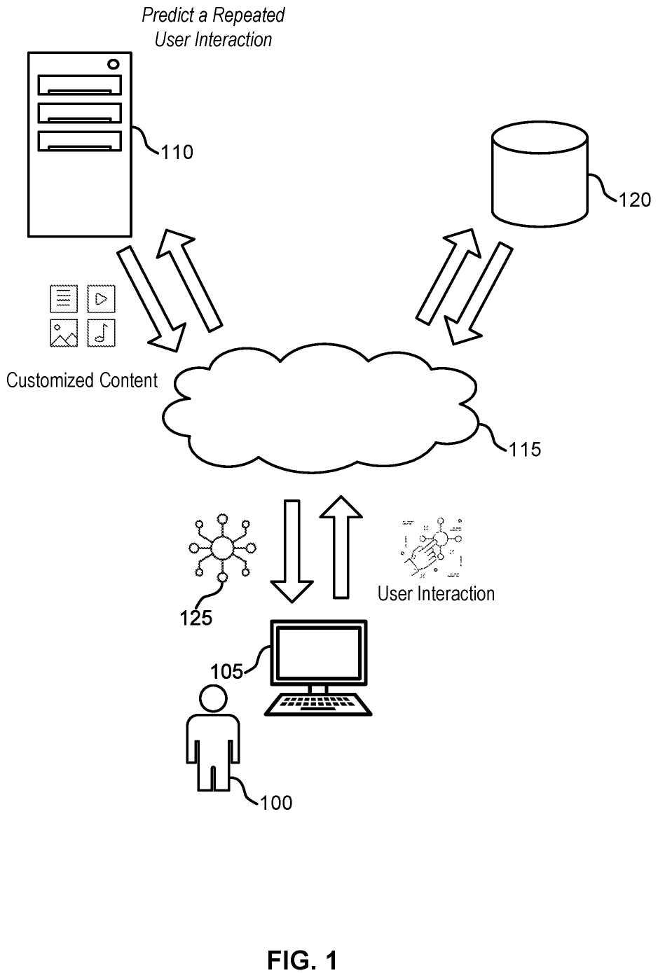

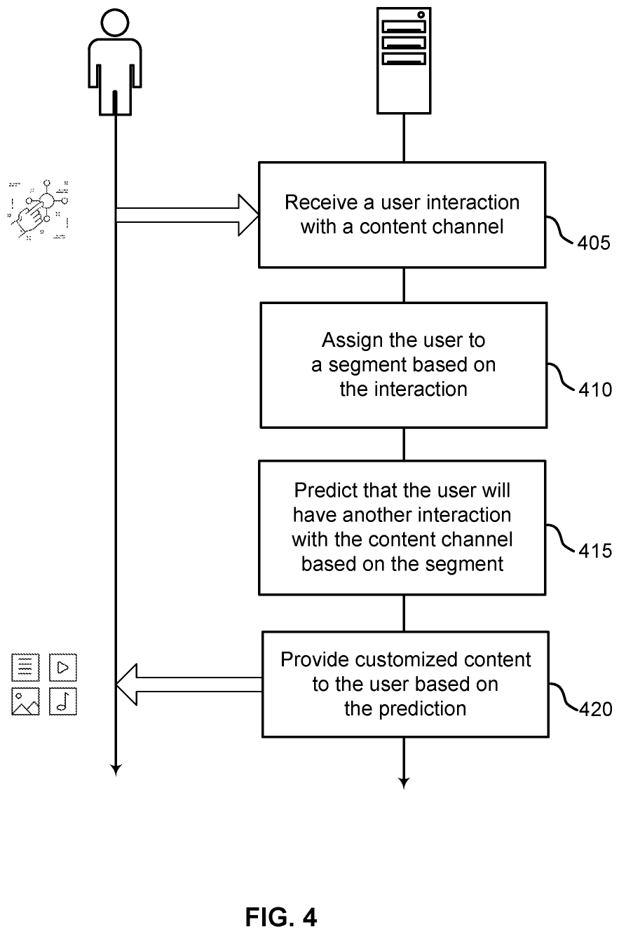

Further example applications of the use of the system in a content distribution context are provided with reference to FIGS. 1 and 4. Details regarding the architecture of the segment size estimation system are provided with reference to FIGS. 1-3. Details regarding a process for segment size estimation are provided with reference to FIGS. 4-6.

### Segment Size Estimation System

A system and apparatus for segment size estimation is described with reference to FIGS. 1-3. One or more aspects of the system and apparatus include a processor; a memory including instructions executable by the processor; a segmentation component configured to identify a segment of the plurality of users for a first time period based on time series data, wherein the time series data includes a series of interactions between a plurality of users and a content channel and wherein the segment includes a portion of the plurality of users interacting with the content channel during the first time period; a prediction component configured to compute a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment; and a content component configured to provide customized content to a user in the segment based on the segment return value.

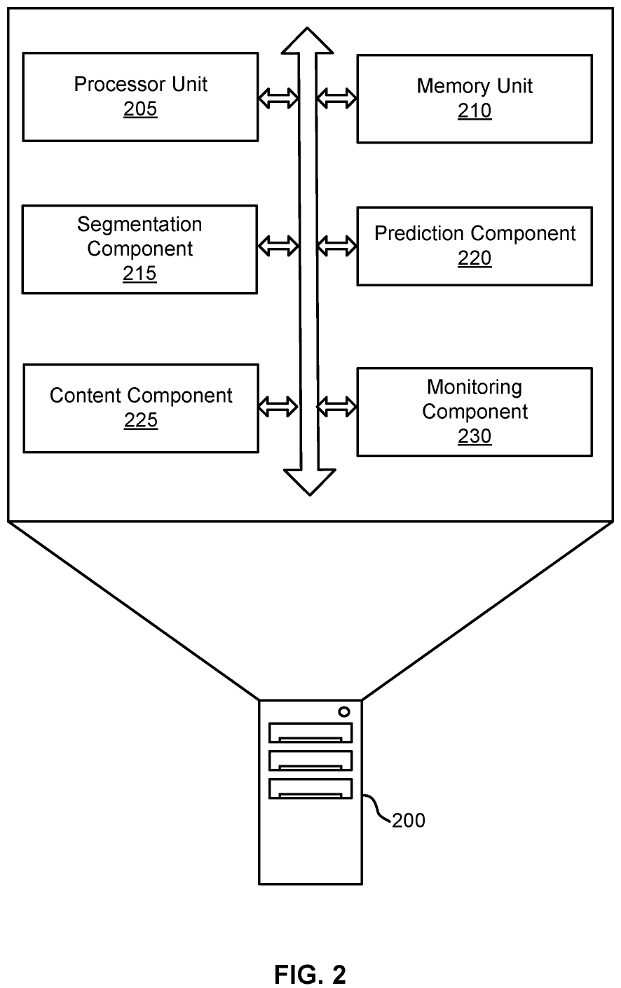

FIG. 1 shows an example of a segment size estimation system according to aspects of the present disclosure. The example shown includes user 100, user device 105, segment size estimation apparatus 110, cloud 115, database 120, and website 125. Segment size estimation apparatus 110 is an example of, or includes aspects of, the corresponding element described with reference to FIG. 2.

In the example of FIG. 1, user 100 interacts with website 125 via user device 105. Website 125 is associated with a content channel. Segment size estimation apparatus 110 receives the interaction with website 125 via cloud 115 and groups user 100 in a segment of users for a first time period according to data associated with the interaction. Segment size estimation apparatus 110 uses the segment and time series data associated with other interactions of users during previous time periods to predict that user 100 will have a repeated interaction with the content channel during a future time period. Segment size estimation apparatus 110 generates customized content for user 100 based on the prediction and the segment, and provides the customized content to user 100 via website 125 and user device 105.

Referring to FIG. 1, according to some aspects, user device 105 is a personal computer, laptop computer, mainframe computer, palmtop computer, personal assistant, mobile device, or any other suitable processing apparatus. In some examples, user device 105 includes software that allows user 100 to interact with website 125 and to receive customized content from segment size estimation apparatus 110.

According to some aspects, a user interface enables user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, the user interface may be a graphical user interface (GUI).

According to some aspects, segment size estimation apparatus 110 includes a computer implemented network. In some embodiments, segment size estimation apparatus 110 also includes one or more processors, a memory subsystem, a communication interface, an I/O interface, one or more user interface components, and a bus. In some embodiments, segment size estimation apparatus 110 communicates with user device 105, database 120, and website 125 via cloud 115.

In some cases, segment size estimation apparatus 110 is implemented on a server. A server provides one or more functions to users linked by way of one or more of various networks, such as cloud 115. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP) and simple mail transfer protocol (SMTP), although other protocols such as file transfer protocol (FTP) and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

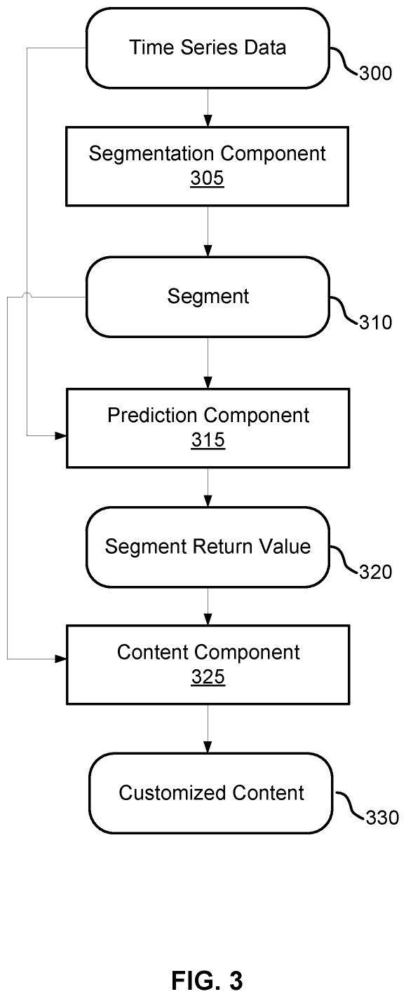

Further detail regarding the architecture of segment size estimation apparatus 110 is provided with reference to FIGS. 2-3. Further detail regarding a process for segment size estimation is provided with reference to FIGS. 4-6.

According to some aspects, cloud 115 is a computer network configured to provide on-demand availability of computer system resources, such as data storage and computing power. In some examples, cloud 115 provides resources without active management by user 100. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location. According to some aspects, cloud 115 provides communications between user device 105, segment size estimation apparatus 110, database 120, and website 125.

According to some aspects, database 120 is an organized collection of data. In some embodiments, database 120 stores data in a specified format known as a schema. According to some aspects, database 120 is structured as a single database, a distributed database, multiple distributed databases, an emergency backup database, or a combination thereof. In some cases, a database controller manages data storage and processing in database 120. In some cases, user 100 interacts with the database controller. In other cases, the database controller operates automatically without user interaction. In some aspects, database 120 is external to segment size estimation apparatus 110 and communicates with segment size estimation apparatus 110 via cloud 115. In some embodiments, database 120 is included in segment size estimation apparatus 110.

According to some aspects, website 125 includes each web page associated with website 125. According to some aspects, user 100 interacts with website 125 via a web browser or other software application included in user device 105. According to some aspects, website 125 is associated with a content channel. For example, in some cases, the content channel comprises website 125. In some cases, a third-party user associated with the content channel operates website 125. In some cases, website 125 is provided by a third-party user for interacting with the content channel.

FIG. 2 shows an example of a segment size estimation apparatus according to aspects of the present disclosure. Segment size estimation apparatus 200 is an example of, or includes aspects of, the corresponding element described with reference to FIG. 1. In one aspect, segment size estimation apparatus 200 includes processor unit 205, memory unit 210, segmentation component 215, prediction component 220, content component 225, and monitoring component 230.

According to some aspects, processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some embodiments, processor unit 205 includes special-purpose components for modem processing, baseband processing, digital signal processing, or transmission processing.

According to some aspects, memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 205 to perform various functions described herein. In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

According to some aspects, segmentation component 215 identifies a segment of a set of users for a first time period based on time series data, where the time series data includes a series of interactions between a set of users and a content channel and where the segment includes a portion of the set of users interacting with the content channel during the first time period. In some examples, segmentation component 215 identifies a set of attributes characterizing the set of users. In some examples, segmentation component 215 selects an attribute of the set of attributes, where the segment is identified based on the selected attribute.

According to some aspects, segmentation component 215 is configured to identify a segment of a plurality of users for a first time period based on time series data, wherein the time series data includes a series of interactions between a plurality of users and a content channel and wherein the segment includes a portion of the plurality of users interacting with the content channel during the first time period.

Segmentation component 215 is an example of, or includes aspects of, the corresponding element described with reference to FIG. 3. According to some aspects, segmentation component 215 is implemented as one or more hardware circuits, as firmware, as software stored in memory of memory unit 210 and executed by a processor of processor unit 205, or as a combination thereof.

According to some aspects, prediction component 220 computes a segment return value for a second time period based on the time series data by computing a first subset and a second subset of the segment, where the first subset includes users that interact with the content channel greater than a threshold number of times during a range of the time series data and the second subset includes a complement of the first subset with respect to the segment.

In some aspects, the first subset includes users that interact with the content channel more than one time during the first time period. In some aspects, the first subset includes users that interact with the content channel at least one time during one or more time periods before the first time period.

In some aspects, the segment return value includes a number of users predicted to interact with the content channel during the second time period. In some aspects, the segment return value includes a ratio between a number of users predicted to interact with the content channel during the second time period and a number of users in the segment during the first period.

In some examples, prediction component 220 generates a first return value for the first subset based on the time series data, where the segment return value is based on the first return value. In some examples, prediction component 220 generates a second return value for the second subset based on the time series data, where the segment return value is based on the first return value and the second return value.

In some examples, prediction component 220 computes a moving average estimator for the first return value based on a set of time periods before the first time period, where the first return value is based on the moving average estimator. In some aspects, the moving average estimator includes an autoregressive moving average.

In some examples, prediction component 220 computes a seasonal parameter of the time series data, where the moving average estimator is based on the seasonal parameter. In some examples, prediction component 220 identifies a frequency for the time series data. In some examples, prediction component 220 selects a model for computing the segment return value based on the frequency.

According to some aspects, prediction component 220 computes a first return value for a first subset of a segment of the set of users and a second return value for a second subset of the segment of the set of users based on the time series data, where the segment includes a portion of the set of users interacting with the content channel during a first time period, where the first subset includes users that interact with the content channel greater than a threshold number of times during a range of the time series data, and where the second subset includes a complement of the first subset with respect to the segment.

In some examples, prediction component 220 predicts a segment return value for a second time period subsequent to the first time period based on the first subset and the second subset of the segment. In some examples, prediction component 220 computes a moving average estimator for the first return value based on a set of time periods before the first time period, where the first return value is based on the moving average estimator. In some aspects, the segment return value includes a ratio between a number of users predicted to interact with the content channel during the second time period and a number of users in the segment during the first period.

According to some aspects, prediction component 220 is configured to compute a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment.

Prediction component 220 is an example of, or includes aspects of, the corresponding element described with reference to FIG. 3. According to some aspects, prediction component 220 is implemented as one or more hardware circuits, as firmware, as software stored in memory of memory unit 210 and executed by a processor of processor unit 205, or as a combination thereof.

According to some aspects, content component 225 provides customized content to a user in the segment based on the segment return value. In some examples, content component 225 generates the customized content for the segment based on the segment return value. In some aspects, the customized content is provided to the user via the content channel. According to some aspects, content component 225 provides customized content to a user in the segment based on the segment return value.

According to some aspects, content component 225 is configured to provide customized content to a user in the segment based on the segment return value.

Content component 225 is an example of, or includes aspects of, the corresponding element described with reference to FIG. 3. According to some aspects, content component 225 is implemented as one or more hardware circuits, as firmware, as software stored in memory of memory unit 210 and executed by a processor of processor unit 205, or as a combination thereof.

According to some aspects, monitoring component 230 generates a cookie for the user based on an interaction of the user with the content channel. In some examples, monitoring component 230 inserts code for monitoring the content channel in a website associated with the content channel. In some examples, monitoring component 230 collects the time series data based on the code. According to some aspects, monitoring component 230 monitors a content channel to collect time series data for a set of users.

According to some aspects, monitoring component 230 is implemented as one or more hardware circuits, as firmware, as software stored in memory of memory unit 210 and executed by a processor of processor unit 205, or as a combination thereof.

FIG. 3 shows an example of data flow in a segment size estimation apparatus according to aspects of the present disclosure. The example shown includes time series data 300, segmentation component 305, segment 310, prediction component 315, segment return value 320, content component 325, and customized content 330.

Segmentation component 305 is an example of, or includes aspects of, the corresponding element described with reference to FIG. 2. Prediction component 315 is an example of, or includes aspects of, the corresponding element described with reference to FIG. 2. Content component 325 is an example of, or includes aspects of, the corresponding element described with reference to FIG. 2.

Referring to FIG. 3, segmentation component 305 receives time series data 300 and identifies segment 310 based on time series data 300. Prediction component 315 receives segment 310 and time series data 300 and computes segment return value 320 for segment 310 based on time series data 300. Content component 325 receives segment return value 320 from prediction component 315 and generates customized content 330 for segment 310 based on segment return value 320. In an example, content component 325 receives segment return value 320 from prediction component 315 and segment 310 from segmentation component 305 to generate customized content 330.

### Segment Size Estimation

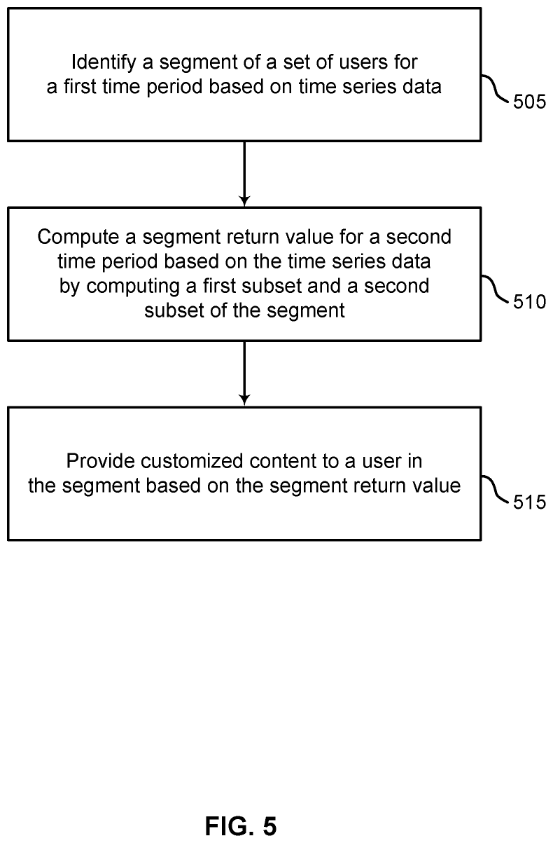

A method for segment size estimation is described with reference to FIGS. 4-5. One or more aspects of the method include identifying a segment of a plurality of users for a first time period based on time series data, wherein the time series data includes a series of interactions between the plurality of users and a content channel and wherein the segment includes a portion of the plurality of users interacting with the content channel during the first time period; computing a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment; and providing customized content to a user in the segment based on the segment return value.

In some aspects, the first subset includes users that interact with the content channel more than one time during the first time period. In some aspects, the first subset includes users that interact with the content channel at least one time during one or more time periods before the first time period.

Some examples of the method further include identifying a plurality of attributes characterizing the plurality of users. Some examples further include selecting an attribute of the plurality of attributes, wherein the segment is identified based on the selected attribute.

Some examples of the method further include generating a cookie for the user based on an interaction of the user with the content channel. Some examples further include determining that the user is in the segment based on the cookie, wherein the customized content is provided based on the determination.

Some examples of the method further include inserting code for monitoring the content channel in a website associated with the content channel. Some examples further include collecting the time series data based on the code.

Some examples of the method further include generating the customized content for the segment based on the segment return value. In some aspects, the customized content is provided to the user via the content channel.

Some examples of the method further include generating a first return value for the first subset based on the time series data, wherein the segment return value is based on the first return value. Some examples of the method further include generating a second return value for the second subset based on the time series data, wherein the segment return value is based on the first return value and the second return value.

Some examples of the method further include computing a moving average estimator for the first return value based on a plurality of time periods before the first time period, wherein the first return value is based on the moving average estimator. In some aspects, the moving average estimator comprises an autoregressive moving average.

Some examples of the method further include computing a seasonal parameter of the time series data, wherein the moving average estimator is based on the seasonal parameter. In some aspects, the segment return value comprises a number of users predicted to interact with the content channel during the second time period.

In some aspects, the segment return value comprises a ratio between a number of users predicted to interact with the content channel during the second time period and a number of users in the segment during the first period.

Some examples of the method further include identifying a frequency for the time series data. Some examples further include selecting a model for computing the segment return value based on the frequency.

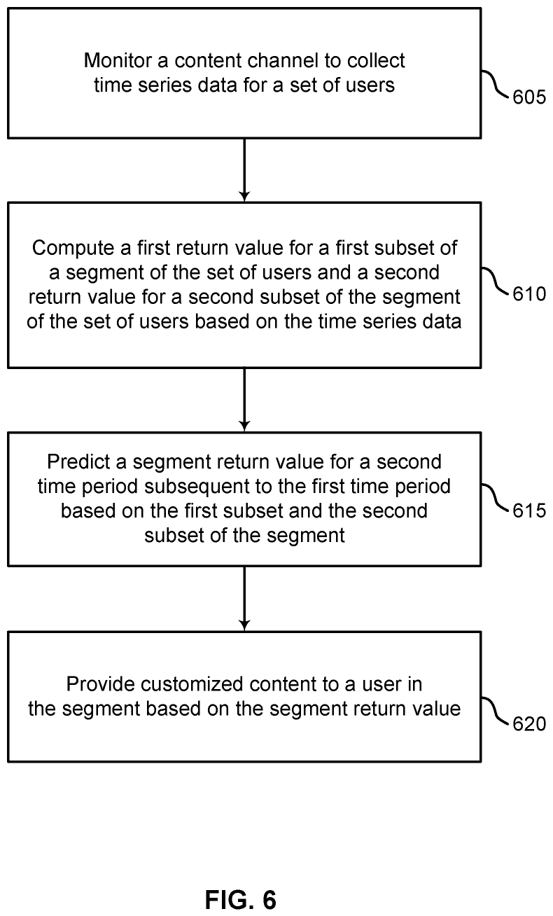

A method for segment size estimation is described with reference to FIG. 6. One or more aspects of the method include monitoring a content channel to collect time series data for a plurality of users; computing a first return value for a first subset of a segment of the plurality of users and a second return value for a second subset of the segment of the plurality of users based on the time series data, wherein the segment includes a portion of the plurality of users interacting with the content channel during a first time period, wherein the first subset includes users that interact with the content channel greater than a threshold number of times during a range of the time series data, and wherein the second subset comprises a complement of the first subset with respect to the segment; predicting a segment return value for a second time period subsequent to the first time period based on the first subset and the second subset of the segment; and providing customized content to a user in the segment based on the segment return value.

Some examples of the method further include computing a moving average estimator for the first return value based on a plurality of time periods before the first time period, wherein the first return value is based on the moving average estimator. In some aspects, the segment return value comprises a ratio between a number of users predicted to interact with the content channel during the second time period and a number of users in the segment during the first period.

FIG. 4 shows an example of customizing content based on a predicted future user interaction according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 4, a system according to an aspect of the present disclosures is used to segment a user who interacts with a content channel during a first time period, to determine a likelihood that the user will interact with the content channel during a second time period, and to provide content to the user based on the determination.

In an example use case, a user from Chicago visits a home page of a website on a first day with a browser installed on a laptop computer that is running an operating system. The system receives this information from the website via a cookie that the website reports to the system. The system uses the information in the cookie to assign the user to a first segment of users who interact with the website on the first day with the browser, laptop computer, and operating system. Based on data that the system has received for segments of users who have interacted with the website on previous days with the browser, laptop computer, and operating system, the system estimates a number of users in the first segment who will interact with the website on a following day. If the estimated number of users is large enough, the system predicts that it is likely that the user will interact with the website on the following day.

In response to predicting that it is likely that the user will return to the website on the following day, the system determines that it is an efficient use of resources to provide to the user a video that is customized for users from Chicago who visit the website using the browser, laptop computer, and operating system. The system then displays the video to the user via the website in response to the determination.

At operation 405, the system receives a user interaction with a content channel. In some cases, the operations of this step refer to, or may be performed by, a segment size estimation apparatus as described with reference to FIGS. 1 and 2. For example, in some cases, the system receives the user interaction with the content channel as described with reference to FIG. 5.

At operation 410, the system assigns the user to a segment based on the interaction. In some cases, the operations of this step refer to, or may be performed by, a segment size estimation apparatus as described with reference to FIGS. 1 and 2. For example, in some cases, the system assigns the user to the segment based on the interaction as described with reference to FIG. 5. In some cases, the segment comprises users who interact with the content channel in a first time period.

At operation 415, the system predicts that the user will have another interaction with the content channel based on the segment. In some cases, the operations of this step refer to, or may be performed by, a segment size estimation apparatus as described with reference to FIGS. 1 and 2. For example, in some cases, the system computes a segment return value for the segment as described with reference to FIG. 5. In some cases, the segment return value comprises a number of users in the segment who are predicted to interact with the content channel in a second time period after the first time period. In some cases, the system predicts that the user will have another interaction with the content channel when the segment return value exceeds a segment return threshold.

At operation 420, the system provides customized content to the user based on the prediction. In some cases, the operations of this step refer to, or may be performed by, a segment size estimation apparatus as described with reference to FIGS. 1 and 2. For example, in some cases, the system provides the customized content to the user as described with reference to FIG. 5.

FIG. 5 shows an example of providing customized content based on a segment return value according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, according to some aspects, the system receives an interaction between a user and a content channel during a first time period and segments the user according to data derived from the interaction in a segment of users who correspond to similar data for the first time period. According to some aspects, the system identifies a first subset and a second subset of the segment. In some cases, the first subset comprises users that interact with the content channel greater than a threshold number of times during a range of the time series data, and the second subset comprises a complement of the first subset with respect to the segment.

According to some aspects, the system computes a segment return value for the segment based on the first subset and the second subset. In some cases, the segment return value comprises a number of users in the segment who the system predicts will interact with the content channel during a second time period subsequent to the first time period (e.g., a number of return user). In some cases, the prediction is based on a first return value calculated for the first subset. In some cases, the prediction is based on the first return vale and on a second return value calculated for the second subset. By basing the computation of the segment return value on the first subset and the second subset, the system is able to achieve a more accurate prediction of the number of return users for the segment than a prediction using the segment alone provides.

According to some aspects, by determining the segment return value for the segment, the system is thereby provided with a likelihood of the amount of return users to the content channel, and is therefore able to efficiently allocate resources (such as customized content tailored to users included in the segment) to a user in the segment in anticipation of the user's return to the content channel during the future time period.

At operation 505, the system identifies a segment of a set of users for a first time period based on time series data. In some cases, the operations of this step refer to, or may be performed by, a segmentation component as described with reference to FIGS. 2 and 3.

According to some aspects, the time series data includes a series of interactions between a plurality of users and a content channel. For example, the time series data can include any data that is descriptive of a user, a content channel, and an interaction at the time of the interaction. Examples of data that are descriptive of a user include a user name, a type of user device, a web browser of the user, a mailing address of the user, a billing address of the user, a location of the user device, an operating system of the user device, etc. Examples of data that are descriptive of a content channel include the name of the content channel, a name of a website associated with the content channel, a location of the content channel, etc. Examples of data that are descriptive of an interaction include a type of interaction (such as a visit to a URL, leaving a URL, a referrer URL, a click on a hyperlink, adding or removing a product to or from a virtual shopping cart, a check-in to a physical location using a user device, the presence of a user device within a geofenced area, etc.), a date of the interaction, a time of the interaction, etc. According to some aspects, the monitoring component receives time series data for time periods prior to the first time period. According to some aspects, the monitoring component stores the time series data in a database, such as the database as described with reference to FIG. 1.

According to some aspects, the segment includes a portion of a set of users interacting with the content channel during the first time period. For example, in some cases, a monitoring component as described with reference to FIG. 2 inserts code for monitoring the content channel in a website associated with the content channel. In some cases, the monitoring component collets the time series data based on the code. For example, in some cases, the monitoring component generates a cookie (or other identifying data) for the user based on an interaction of the user with the content channel using the code.

As used herein, a “cookie” is an item of data that includes data relating to the interaction between the user and the content channel via the website associated with the content channel. As used herein, “other identifying data” is data that relates to the interaction between the user and the content channel. In some cases, the monitoring component collects the time series data based on the code (for example, by collecting a set of cookies from the website and collecting data from the cookies as the time series data), and provides the time series data to the segmentation component. In some cases, the monitoring component provides the cookie for the user to the segmentation component.

According to some aspects, the segmentation component identifies a set of attributes characterizing the set of users and selects an attribute of the set of attributes. For example, in some cases, the set of attributes characterizing the set of users corresponds to the user data, content channel data, and interaction data included in the time series data. As used herein, an “attribute” refers to any combination of user data, content channel data, and interaction data included in the time series data. An example of an attribute includes “a user with a mailing address in New York who interact with a given content channel using a given smartphone device”.

In some cases, the segmentation component identifies the segment based on the selected attribute. For example, the segmentation component identifies each user who corresponds to data that is included in the selected attribute and assigns the user to a segment corresponding to the selected attribute. In some cases, the segmentation component determines that the user is in the segment based on data included in the cookie (or other identifying data). According to some aspects, in response to the determination, the segmentation component associates the user with the segment and stores the association in a database, such as the database as described with reference to FIG. 1. According to some aspects, the segmentation component provides data indicating the determination to a content component as described with reference to FIGS. 2 and 3.

According to some aspects, the segmentation component includes each user who interacts with the content channel during the first time period Tₖ in a set Ωₖ. In some cases, the first time period Tₖ may be a single day. In some cases, the first time period Tₖ may be a set of contiguous days (e.g., June 1, June 2, June 3, etc.) or a set of dis-contiguous days (e.g., June 1, June 3, June 6, etc.). According to some aspects, the segment Sₖ includes each user who is associated with time series data that is included in the selected attribute for the first time period Tₖ.

At operation 510, the system computes a segment return value for a second time period based on the time series data by computing a first subset and a second subset of the segment. In some cases, the operations of this step refer to, or may be performed by, a prediction component as described with reference to FIGS. 2 and 3.

According to some aspects, the segment return value is a numerical representation of a number of users in segment Sₖ who are predicted to interact with the content channel in a second time period Tₖ₊₁ subsequent to the first time period Tₖ, where a user who interacts with the content channel in the second time period Tₖ₊₁ is included in a set Ωₖ₊₁. For example, in some cases, the segment return value is the intersection of segment Sₖ and set Ωₖ₊₁: |Sₖ∩Ωₖ₊₁|. According to some aspects, the segment return value rₖ comprises a number of users predicted to interact with the content channel during the second time period Tₖ₊₁.

According to some aspects, the segment return value is expressed as a ratio rₖ of the intersection of the segment Sₖ and the set Ωₖ₊₁ to the segment Sₖ:

$${r}_{k} = \frac{\vert {S}_{k} ⋂ {Ω}_{k + 1} \vert}{\vert {S}_{k} \vert} \qquad ( 1 )$$

In some cases, the ratio rₖ at k is estimated or evaluated using the past segment return values (e.g., r₁, r₂, rₖ₋₁)

According to some aspects, the ratio rₖ comprises a ratio between a number of users Ωₖ₊₁ predicted to interact with the content channel during the second time period Tₖ₊₁ and a number of users in the segment Sₖ during the first time period.

According to some aspects, the first subset Vₖ includes users that interact with the content channel greater than a threshold number of times during a range of the time series data and the second subset Uₖ comprises a complement of the first subset with respect to the segment Sₖ(e.g., Uₖ=Sₖ\Vₖ). As used herein, the range of time series data includes any time period for which the monitoring component has received time series data (e.g., time periods Tₖ₋₁, Tₖ₋₂, Tₖ₋₃, . . . Tₖ₋ₜ prior to the first time period Tₖ). According to some aspects, the threshold number of times is stored in a database such as the database as described with reference to FIG. 1 and is retrieved by the prediction component.

For example, in some cases, the first subset Vₖ includes users of the segment that interact with the content channel more than one time during the first time period Tₖ. In this case, the threshold number of times is one. In some cases, the first subset Vₖ includes users that interact with the content channel at least one time during one or more time periods Tₖ₋₁ . . . Tₖ₋ₜ before the first time period Tₖ. In this case, the threshold number of times is zero during one or more time periods Tₖ₋₁ . . . Tₖ₋ₜ before the first time period Tₖ.

According to some aspects, the prediction component generates a first return value for the first subset based on the time series data. According to some aspects, the first return value rₖ^{V} for the first subset is a numerical representation of a number of users in the first subset Vₖ who are predicted to interact with the content channel in a second time period Tₖ₊₁ subsequent to the first time period Tₖ, where a user who interacts with the content channel in the second time period Tₖ₊₁ is included in the set Ωₖ₊₁. According to some aspects, the first return value rₖ^{V} is expressed as a ratio of the intersection of the first subset Vₖ and the set Ωₖ₊₁ to the first subset Vₖ:

$${r}_{k}^{V} = \frac{\vert {V}_{k} ⋂ {Ω}_{k + 1} \vert}{\vert {V}_{k} \vert} \qquad ( 2 )$$

According to some aspects, the prediction component estimates the first return value rₖ^{V} using the estimator rₖ₋₁^{V}:

$$= {r}_{k - 1}^{V} = \frac{\vert {V}_{k - 1} ⋂ {Ω}_{k} \vert}{\vert {V}_{k - 1} \vert} \qquad ( 3 )$$

For example, in some cases, the prediction component computes the first return value rₖ^{V} as being equal to the value of the estimator rₖ₋₁^{V}. In some cases, sets of users Vₖ₋₁, Vₖ₋₂, Vₖ₋₃ . . . Vₖ₋ₜ for any given t include users who share the selected attribute with users in the first subset Vₖ apart from a time of an interaction with the content channel. In this case, t indicates the time period of the interaction with the content channel.

According to some aspects, the prediction component estimates the first return value rₖ^{V} using the reverse estimator Reverseₖ^{V}:

$$= {Reverse}_{k}^{y} = \frac{\vert {V}_{k} ⋂ {Ω}_{k - 1} \vert}{\vert {V}_{k} \vert} \qquad ( 4 )$$

For example, in some cases, the prediction component computes the first return value rₖ^{V} as being equal to the value of the reverse estimator Reverserₖ^{V}. According to some aspects, the prediction component uses a regression process to correct a bias of the reverse estimator Reverseₖ^{V} in order to predict the first return value rₖ^{V} for some fixed time period t:

rₖ^{V}=αₖ^{V}Reverseₖ^{V}+αₖ₋₁^{V}Reverseₖ₋₁^{V}+ . . . αₖ₋ₜ^{V}Reverseₖ₋ₜ^{V} (5)

According to some aspects, the prediction component obtains the α parameters of equation (5) using linear regression.

According to some aspects, the prediction component computes a moving average estimator for the first return value based on a set of time periods before the first time period. For example, in some cases, the prediction component estimates the first return value rₖ^{V} using a moving average estimator MAₖ^{V}(t) for the first return value rₖ^{V} for t past time periods:

$$= {MA}_{k}^{V} ( t ) = {\sum }_{i = 1}^{t} {r}_{k - i}^{V} \qquad ( 6 )$$

For example, in some cases, the prediction component computes the first return value rₖ^{V} as being equal to the value of the moving average estimator MAₖ^{V}(t) for the first return value rₖ^{V}. According to some aspects, the prediction component applies an exponential smoothing that assigns exponentially decreasing weights to the terms of the moving average estimator MAₖ^{V}(t) for the first return value rₖ^{V}.

According to some aspects, the moving average estimator for the first return value rₖ^{V} comprises an autoregressive moving average. For example, in some cases, the prediction component uses an autoregressive moving average (ARMA) model to compute the autoregressive moving average using the time series data included in the range of the time series data. For example, in some cases, the prediction component uses an autoregressive integrated moving average (ARIMA) model to compute the autoregressive moving average using the time series data included in the range of the time series data, and the autoregressive moving average comprises an autoregressive integrated moving average. According to some aspects, the first return value rₖ^{V} is computed to be equal to the autoregressive moving average.

According to some aspects, the segment return value is based on the first return value r^{V}. For example, in some cases, the prediction component estimates the segment return value to be approximately equal to the first return value rₖ^{V}. In some cases, the prediction component estimates the segment return value based on the intersection of the first subset Vₖ and the set Ωₖ₊₁ (e.g., |Vₖ∩Ωₖ₊₁|):

rₖ^{V}|Vₖ|=|Vₖ∩Ωₖ₊₁|≈|Sₖ∩Ωₖ₊₁| (7)

According to some aspects, the prediction component generates a second return value for the second subset based on the time series data. According to some aspects, the second return value rₖ^{U} for the second subset is a numerical representation of a number of users in the second subset Uₖ who are predicted to interact with the content channel in a second time period Tₖ₊₁ subsequent to the first time period Tₖ, where a user who interacts with the content channel in the second time period Tₖ₊₁ is included in the set Ωₖ₊₁. According to some aspects, the second return value rₖ^{U} is expressed as a ratio of the intersection of the second subset Uₖ and the set Ωₖ₊₁ to the second subset Uₖ:

$${r}_{k}^{U} = \frac{\vert {U}_{k} ⋂ {Ω}_{k + 1} \vert}{\vert {U}_{k} \vert} \qquad ( 8 )$$

According to some aspects, the prediction component estimates the second return value rₖ^{U} using the estimator rₖ₋₁^{U}:

$$= {r}_{k - 1}^{U} = \frac{\vert {U}_{k - 1} ⋂ {Ω}_{k} \vert}{\vert {U}_{k - 1} \vert} \qquad ( 9 )$$

For example, in some cases, the prediction component computes the second return value rₖ^{U} as being equal to the value of the estimator rₖ₋₁^{U}. In some cases, sets of users Uₖ₋₁, Uₖ₋₂, Vₖ₋₃ . . . Uₖ₋ₜ for any given t include users who share the selected attribute with users in the second subset Uₖ apart from a time of an interaction with the content channel. In this case, t indicates the time period of the interaction with the content channel.

According to some aspects, the prediction component estimates the second return value rₖ^{U} using the reverse estimator Reverseₖ^{U}:

$$= {Reverse}_{k}^{U} = \frac{\vert {U}_{k} ⋂ {Ω}_{k - 1} \vert}{\vert {U}_{k} \vert} \qquad ( 10 )$$

For example, in some cases, the prediction component computes the second return value rₖ^{U} as being equal to the value of the reverse estimator Reverseₖ^{U}. According to some aspects, the prediction component uses a regression process to correct a bias of the reverse estimator Reverseₖ^{U} in order to predict the second return value rₖ^{U} for some fixed t:

rₖ^{U}=αₖ^{U}Reverseₖ^{U}+αₖ₋₁^{U}Reverseₖ₋₁^{U}+ . . . αₖ₋ₜ^{U}Reverseₖ₋ₜ^{U} (11)

According to some aspects, the prediction component obtains the α parameters of equation (11) using linear regression.

According to some aspects, the prediction component computes a moving average estimator for the second return value based on a set of time periods before the first time period. For example, in some cases, the prediction component estimates the second return value rₖ^{U} using a moving average estimator MAₖ^{U}(t) for the second return value rₖ^{U} for t past time periods:

$$= {MA}_{k}^{U} ( t ) = {\sum }_{i = 1}^{t} {r}_{k - i}^{U} \qquad ( 12 )$$

For example, in some cases, the prediction component computes the second return value rₖ^{U} as being be equal to the value of the moving average estimator MAₖ^{U}(t) for the second return value rₖ^{U}. According to some aspects, the prediction component applies an exponential smoothing that assigns exponentially decreasing weights to the terms of the moving average estimator MAₖ^{U}(t) for the second return value rₖ^{U}.

According to some aspects, the moving average estimator for the second return value rₖ^{U} comprises an autoregressive moving average. For example, in some cases, the prediction component uses ARMA model to compute the autoregressive moving average using the time series data included in the range of the time series data. For example, in some cases, the prediction component uses an ARIMA model to compute the autoregressive moving average using the time series data included in the range of the time series data, and the autoregressive moving average comprises an autoregressive integrated moving average. According to some aspects, the second return value rₖ^{U} is computed to be equal to the autoregressive moving average.

According to some aspects, the segment return value rₖ is based on the first return value rₖ^{V} and the second return value rₖ^{U}. For example, in some cases, the prediction component computes the segment return value rₖ by combining the first return value rₖ^{V} and the second return value rₖ^{U} to obtain a number of users in a segment Sₖ who will interact with the channel during the second time period Tₖ₊₁ (e.g., |Sₖ∩Ωₖ₊₁|):

rₖ^{V}|Vₖ|+rₖ^{U}|Uₖ|=|Vₖ∩Ωₖ₊₁|+|Uₖ∩Ωₖ₊₁|=|Sₖ∩Ωₖ₊₁| (13)

By combining the first return value and the second return value to determine the segment return value, the prediction component increases the accuracy of the segment return value from an accuracy that would be obtained by computing the segment return value without identifying the first subset and the second subset.

According to some aspects, the prediction component identifies a frequency for the time series data. According to some aspects, the prediction component selects a model for computing the segment return value based on the frequency. For example, in some cases, the time series data includes a seasonal pattern that corresponds to an intrinsic frequency ƒ. As used herein, a “seasonal pattern” refers to a fixed and known frequency. For example, when data regularly and predictably changes and occurs or repeats over a period of time, the frequency of these consistent changes is referred as a seasonal pattern.

In some cases, in response to the time series data including a seasonal pattern, the prediction component selects a moving average estimator model for computing the segment return value and computes the moving average estimator(s) for the first subset rₖ^{V} and/or the second subset rₖ^{U} according to the following:

$${MA}_{k}^{V} ( t ) = {\sum }_{i = 1}^{t} {r}_{k - i \cdot f}^{V} \qquad ( 14 )$$

$${MA}_{k}^{U} ( t ) = {\sum }_{i = 1}^{t} {r}_{k - i \cdot f}^{U} \qquad ( 15 )$$

In some cases, in response to the time series data including a seasonal pattern, the prediction component selects an ARIMA model for computing the segment return value and computes the moving average estimator(s) for the first subset rₖ^{V} and/or the second subset rₖ^{U} using an ARIMA model that includes a seasonal parameter computed by the prediction component to capture lags that are multiples of the intrinsic frequency ƒ.

According to some aspects, the prediction component computes the first subset rₖ^{V} and/or the second subset rₖ^{U} using r_{k-ƒ}^{V} and r_{k-ƒ}^{U}, respectively.

By estimating a segment return value that includes a number of users who are in the segment Sₖ (e.g., users who correspond to data that is included in the selected attribute, which includes an interaction with the content channel during a first time period) and who are predicted to interact with the content channel during a second time period subsequent to the first time period, the prediction component therefore provides information that is useful in efficiently allocating resources for the segment and/or the content channel, or in determining that the segment should be exported to a data collection system. By computing the segment return value based on the first subset and the second subset, the prediction component increases the accuracy of the segment return value.

An example of an efficient allocation of resources is a determination of content to be provided to a user of the segment when it is known, via the segment return value, that the user is likely to have a repeat interaction with the content channel during a future time period. Another example of an efficient allocation of resources is determining an amount of bandwidth, servers, cloud-based services, and the like that should be provided for the content channel based on the segment return value.

At operation 515, the system provides customized content to a user in the segment based on the segment return value. In some cases, the operations of this step refer to, or may be performed by, a content component as described with reference to FIGS. 2 and 3.

According to some aspects, the prediction component provides the segment return value for the segment Sₖ to the content component. According to some aspects, in response to receiving the segment return value for the segment Sₖ, the content component generates customized content for the segment based on the segment return value.

For example, in some cases, content is associated with the selected attribute for the segment via a data schema in a database such as the database as described with reference to FIG. 1. According to some aspects, the content component generates the customized content by retrieving content (or data that identifies content) that corresponds to the selected attribute from the database and associating the retrieved content or data that identifies the content with the segment. According to some aspects, the content component generates the customized content in response to determining that the segment return value for the segment exceeds a segment return threshold. In some cases, the segment size threshold is stored in the database.

According to some aspects, the content component receives the determination from the segmentation component that a user is in the segment. According to some aspects, the content component retrieves data indicating the determination from the database. According to some aspects, the content component provides the customized content to the user in response to the determination.

According to some aspects, the content component provides the customized content to the user via the content channel. For example, in some cases, the content channel is a digital content channel, and the customized content is media such as text, audio, images, video, or a combination thereof that the content component provides to the user via the digital content channel. For example, in some cases, the content channel is a physical channel such as a mailing service, a physical location such as a store, a hotel, an amusement park, etc., and the like, and the content component directs that customized content such as goods, services, physically tangible media, and the like be provided via the content channel using the data that identifies the content, or provides customized digital content to the user via a website associated with the content channel.

FIG. 6 shows an example of providing customized content based on return values according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system monitors a content channel to collect time series data for a set of users. In some cases, the operations of this step refer to, or may be performed by, a monitoring component as described with reference to FIG. 2. For example, in some cases, the monitoring component collects the time series data for the set of users as described with reference to FIG. 5.

At operation 610, the system computes a first return value for a first subset of a segment of the set of users and a second return value for a second subset of the segment of the set of users based on the time series data. In some cases, the operations of this step refer to, or may be performed by, a prediction component as described with reference to FIGS. 2 and 3. For example, in some cases, the prediction component computes the first return value and the second return value as described with reference to FIG. 5.

In some cases, the segment includes a portion of the plurality of users interacting with the content channel during a first time period. In some cases, the first subset includes users that interact with the content channel greater than a threshold number of times during a range of the time series data. In some cases, the second subset comprises a complement of the first subset with respect to the segment.

At operation 615, the system predicts a segment return value for a second time period subsequent to the first time period based on the first subset and the second subset of the segment. In some cases, the operations of this step refer to, or may be performed by, a prediction component as described with reference to FIGS. 2 and 3. For example, in some cases, the prediction component predicts the segment return value as described with reference to FIG. 5.

In some cases, the prediction component computes a moving average estimator for the first return value based on a plurality of time periods before the first time period, wherein the first return value is based on the moving average estimator. In some cases, the segment return value comprises a ratio between a number of users predicted to interact with the content channel during the second time period and a number of users in the segment during the first period.

At operation 620, the system provides customized content to a user in the segment based on the segment return value. In some cases, the operations of this step refer to, or may be performed by, a content component as described with reference to FIGS. 2 and 3. For example, in some cases, the content component provides the customized content to the user as described with reference to FIG. 5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for segment size estimation, comprising:
identifying, by a segmentation component, a segment of a plurality of users for a first time period based on time series data, wherein the time series data includes a series of interactions between the plurality of users and a content channel and wherein the segment includes a portion of the plurality of users interacting with the content channel during the first time period;
computing, by a prediction component, a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment; and
providing, by a content component, customized content to a user in the segment based on the segment return value.

2. The method of claim 1, wherein:
the first subset includes users that interact with the content channel more than one time during the first time period.

3. The method of claim 1, wherein:
the first subset includes users that interact with the content channel at least one time during one or more time periods before the first time period.

4. The method of claim 1, further comprising:
identifying, by the segmentation component, a plurality of attributes characterizing the plurality of users; and
selecting, by the segmentation component, an attribute of the plurality of attributes, wherein the segment is identified based on the selected attribute.

5. The method of claim 1, further comprising:
generating, by a monitoring component, a cookie for the user based on an interaction of the user with the content channel; and
determining, by the segmentation component, that the user is in the segment based on the cookie, wherein the customized content is provided based on the determination.

6. The method of claim 1, further comprising:
inserting, by a monitoring component, code for monitoring the content channel in a website associated with the content channel; and
collecting, by the monitoring component, the time series data based on the code.

7. The method of claim 1, further comprising:
generating, by the content component, the customized content for the segment based on the segment return value.

8. The method of claim 1, wherein:
the customized content is provided to the user via the content channel.

9. The method of claim 1, further comprising:
generating, by the prediction component, a first return value for the first subset based on the time series data, wherein the segment return value is based on the first return value.

10. The method of claim 9, further comprising:
generating, by the prediction component, a second return value for the second subset based on the time series data, wherein the segment return value is based on the first return value and the second return value.

11. The method of claim 9, further comprising:
computing, by the prediction component, a moving average estimator for the first return value based on a plurality of time periods before the first time period, wherein the first return value is based on the moving average estimator.

12. The method of claim 11, wherein:
the moving average estimator comprises an autoregressive moving average.

13. The method of claim 11, further comprising:
computing, by the prediction component, a seasonal parameter of the time series data, wherein the moving average estimator is based on the seasonal parameter.

14. The method of claim 1, wherein:
the segment return value comprises a number of users predicted to interact with the content channel during the second time period.

15. The method of claim 1, wherein:
the segment return value comprises a ratio between a number of users predicted to interact with the content channel during the second time period and a number of users in the segment during the first time period.

16. The method of claim 1, further comprising:
identifying, by the prediction component, a frequency for the time series data; and
selecting, by the prediction component, a model for computing the segment return value based on the frequency.

17. A method for segment size estimation, comprising:
monitoring, by a monitoring component, a content channel to collect time series data for a plurality of users;
computing, by a prediction component, a first return value for a first subset of a segment of the plurality of users and a second return value for a second subset of the segment of the plurality of users based on the time series data, wherein the segment includes a portion of the plurality of users interacting with the content channel during a first time period, wherein the first subset includes users that interact with the content channel greater than a threshold number of times during a range of the time series data, and wherein the second subset comprises a complement of the first subset with respect to the segment;
predicting, by the prediction component, a segment return value for a second time period subsequent to the first time period based on the first subset and the second subset of the segment; and
providing, by a content component, customized content to a user in the segment based on the segment return value.

18. The method of claim 17, further comprising:
computing, by the prediction component, a moving average estimator for the first return value based on a plurality of time periods before the first time period, wherein the first return value is based on the moving average estimator.

19. The method of claim 17, wherein:
the segment return value comprises a ratio between a number of users predicted to interact with the content channel during the second time period and a number of users in the segment during the first time period.

20. An apparatus for segment size estimation, comprising:
a processor;
a memory including instructions executable by the processor;
a segmentation component configured to identify a segment of a plurality of users for a first time period based on time series data, wherein the time series data includes a series of interactions between the plurality of users and a content channel and wherein the segment includes a portion of the plurality of users interacting with the content channel during the first time period;
a prediction component configured to compute a segment return value for a second time period based on the time series data by computing a first subset and a second subset of the segment, wherein the first subset includes users that interact with the content channel greater than a threshold number of times during a range of the time series data and the second subset comprises a complement of the first subset with respect to the segment; and
a content component configured to provide customized content to a user in the segment based on the segment return value.
